(19) United States
(12) Patent Application Publication
(10) Pub. No.: US 2007/0007019 A1
(43) Pub. Date: Jan. 11, 2007

(54) Hybrid fire extinguisher for extended suppression times

(75) Inventors: Paul H. Wierenga, Seattle, WA (US); Charles E. Vaughan, Woodinville, WA (US); Gary F. Holland, Snohomish, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Aerojet-General Corporation, Redmond, WA (US)

(21) Appl. No.: 11/471,283

(22) Filed: Jun. 19, 2006

Related U.S. Application Data
(60) Provisional application No. 60/691,447, filed on Jun. 17, 2005.

(51) Int. Cl. A62C 11/00; A62C 35/58; A62C 13/22

(52) U.S. Cl. 169/30; 169/77; 169/84; 169/85

(57) ABSTRACT

A hybrid fire extinguisher includes a solid propellant gas generator. The properties of the solid propellant selected for the gas generator can provide a predetermined discharge profile. Fire extinguisher discharge characteristics can be tailored for unique applications. In one embodiment, the discharge of the fire suppressant is controlled to be substantially constant throughout the duration or, at least, the majority of the discharge period.

### CROSS-REFERENCE TO RELATED APPLICATION

This application claims the benefit of Provisional Application No. 60/691,447, filed Jun. 17, 2005, the benefit of which is hereby claimed under 35 U.S.C. §119.

### BACKGROUND

A recent improvement in fire extinguisher technology is the development of the “hybrid” fire extinguisher. A hybrid fire extinguisher combines a solid propellant gas generator and a fire suppressant in a bottle. Upon ignition, the gas generator creates large volumes of gas that leads to rapid pressurization within the bottle and propels and may vaporize the fire suppressant. Conventional fire extinguishers use an inert gas stored under pressure to propel the fire suppressant. The gas can occupy a large portion of the fire extinguisher bottle's volume, and the high pressure is a constant danger. In contrast, a hybrid fire extinguisher stores the propellant gas as a solid under reduced or no pressure. An advantage of a hybrid fire extinguisher is the increase in the quantity of fire suppressant that can be provided in the bottle, since the bottle volume can be occupied by the fire suppressant instead of a gas propellant. A solid propellant gas generator is a much more efficient way of producing a propellant gas.

While a hybrid fire extinguisher represents a significant advance in fire extinguisher technology, the hybrid fire extinguisher can continue to be refined and improved.

### SUMMARY

A hybrid fire extinguisher includes a solid propellant gas generator. The properties of the solid propellant selected for the gas generator can provide a predetermined discharge profile. Fire extinguisher discharge characteristics can be tailored for unique applications. In one embodiment, the discharge of the fire suppressant is controlled to be substantially constant throughout the duration or, at least, the majority of the discharge period. To achieve a substantially constant discharge of fire suppressant, the solid propellant produces a substantially constant pressure, or a slightly increasing pressure, within the container that holds the fire suppressant. Toward this end, the solid propellant surface area that is exposed to burning increases during the discharge period. In another embodiment, the solid propellant characteristics can be tailored so that an initial burst of fire suppressant is followed by a steady, low discharge of fire suppressant for an extended period of time. In another embodiment, the solid propellant characteristics can be tailored so that the burst of fire suppressant can come in the middle or at the end of the discharge period. By proper selection and arrangement of the solid propellant grain size and surface area, the discharge profile of hybrid fire extinguishers can be tailored to specific applications as desired.

This summary is provided to introduce a selection of concepts in a simplified form that are fuirther described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagrammatical illustration of one embodiment of a fire suppression system in accordance with the present invention;

FIG. 2 is a diagrammatical illustration of one embodiment of a fire extinguisher in accordance with the present invention;

FIG. 3 is a diagrammatical illustration of an alternate embodiment of a fire extinguisher in accordance with the present invention;

FIG. 4 is a diagrammatical illustration of a solid propellant gas generator in accordance with the present invention;

FIG. 5 is a graph illustrating a representative discharge profile of a fire extinguisher in accordance with the present invention;

FIG. 6 is a graph illustrating a representative discharge profile of a fire extinguisher in accordance with the present invention;

FIG. 7 is a graph illustrating a representative discharge profile of a fire extinguisher in accordance with the present invention; and

FIG. 8 is a graph illustrating a representative discharge profile of a fire extinguisher in accordance with the present invention.

### DETAILED DESCRIPTION

A fire extinguisher bottle pressurized by a solid propellant in accordance with the present invention can have a tailored discharge profile. For example, a constant overpressure can be applied to the fire suppressant, thereby providing a constant rate of delivery of fire suppressant to the fire. Alternatively, a high pressure can be applied to the fire suppressant, resulting in a faster discharge than can be obtained with a static over pressurizing gas. A high pressure can be applied at the beginning, middle, or towards the end of the discharge profile.

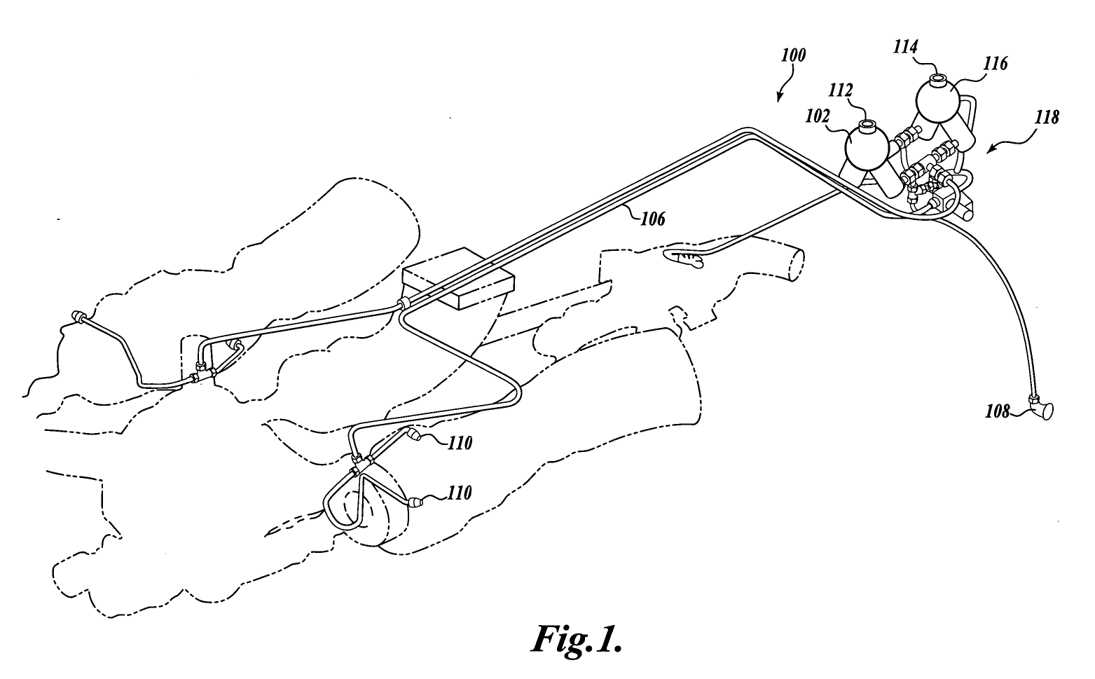

FIG. 1 shows one representative embodiment of the application of a fire extinguisher in accordance with the present invention. In the illustrated embodiment, a fire suppression system 100 is provided for an aircraft. Two bottles 102 and 104 containing fire suppressant are located at any suitable location on the aircraft and preferably distant from any highly flammable jet fuel. The bottles 102 and 104 are piped to deliver fire suppressant to engines (shown in phantom). For example, piping 106 carries the fire suppressant to discharge locations at a first and second aircraft engine. The piping 106 ends at a pair of discharge nozzles 110 at one engine. A second similar pipe can be provided to deliver fire suppressant to a second engine. Valves provided on the piping manifold 118 control the discharge location based on pre-programmed logic using any number of heat or temperature sensors to sense where the fire is occurring. Alternatively, the fire extinguisher system can be activated on the detection of flammable vapors. The system 100 may also include a pressure relief outlet 108 in the event of overpressure of the system. The pressure relief outlet 108 vents safely to the atmosphere.

Fire extinguisher bottles 102 and 104 contain a fire suppressant enclosed within each fire extinguisher bottle. The fire suppressant within bottles 102 and 104 can be kept at depressurized conditions. Fire suppressant agent includes hydrofluorocarbons, perfluorocarbons, CF₃CHFCH₃, C₄F₁₀, (CF₂)₄, HFC-125, HFC-23, HFC-227ea, and HFC-236fa, pentafluoroethane, heptafluoropropane, and any mixtures thereof. Bottles 102 and 104 do not need to be under constant high pressurize to deliver the fire suppressant because pressurizing gas is supplied by solid propellant gas generators 112 and 114 on bottles 102 and 104, respectively. Solid propellant gas generators 112 and 114 will supply pressurizing gas by igniting solid propellant within the gas generators 112 and 114 when needed.

The outlets of bottles 102 and 104 can be connected to one another through a manifold 118 so that both bottles 102 and 104 can discharge to the same location. Alternatively, the bottles 102 and 104 can be isolated from one another. Bottle 102 can be piped only to a single discharge pipe, and bottle 104 can be piped to a separate and independent discharge pipe. However, if either bottle 102 or 104 malfunctions, a cross-tie between bottles 102 and 104 can operate; therefore, bottle 102 can relieve into bottle 104's piping, and vice versa. Bottle 104 can relieve into bottle 102's discharge piping, for mutual redundancy of the system. Control valves and a programmable logic unit can be used in opening and closing manifold valves to cover any number of situations.

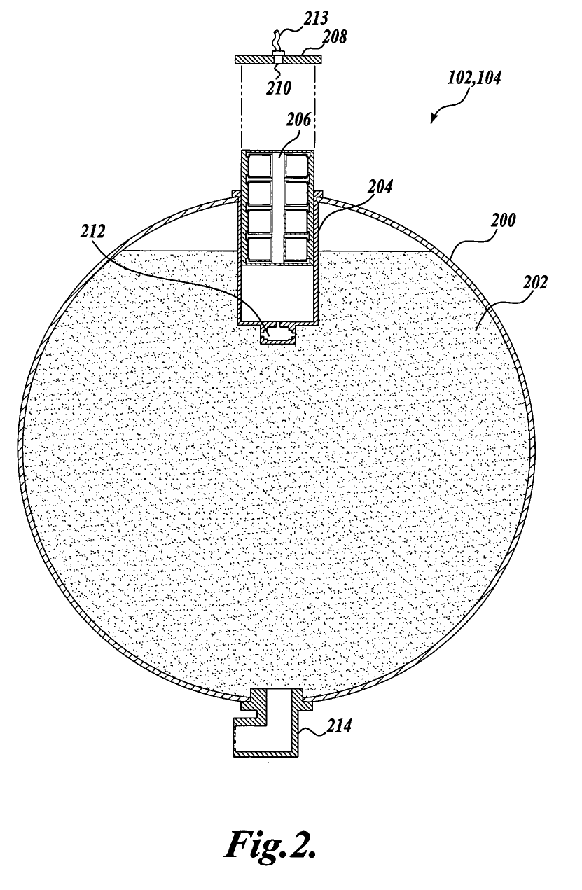

Referring to FIG. 2, a representative embodiment of a bottle, such as for bottles 102 and 104, is illustrated. Fire extinguisher bottles 102 and 104 include a spherical container 200. Although a spherical container is illustrated, the fire suppressant container can be any shape, including cylindrical and/or rectangular. Container 200 includes fire suppressant 202 therein. One advantage of a hybrid fire extinguisher is that the fire suppressant 202 can occupy a greater volume within the container 200 as compared to a fire extinguisher that utilizes propellants that are gases at ambient temperatures. The container 200 includes a discharge nozzle 214. In this embodiment, the discharge nozzle 214 is placed at a lower section of the container 200. The nozzle 214 can be threaded or otherwise attached to the discharge piping. The container 200 also includes a breech 204 located at the upper section of the bottle 200. The breech 204 is sized and configured to hold a gas generator cartridge 206 therein. The breech 204 holds the gas generator cartridge 206 firmly within the container 200. The breech 204 is connected to a propellant gas discharge port 212. The discharge port 212 is located at the bottom section of the breech 204. The discharge port 212 includes one or more apertures that regulate or control the discharge of the gas propellant generated upon ignition of the gas generator cartridge 206. An aperture leads from the breech 204 to the discharge port 212. Apertures on the discharge port 212 lead to the container 200 interior. In the illustrated embodiment, the breech 204 is permanently affixed to the container 200. The gas generator cartridge 206 is disposable once it has been fired. However, an alternative configuration might include a single use fire extinguisher, wherein both the bottle and the gas generator cartridge are discarded after firing. In other alternative embodiments, the breech can be built into the solid propellant gas generator. In the latter embodiment, both the breech and the solid propellant gas generator are discarded after firing. In yet other alternative embodiments, the solid propellant gas generator can be provided at discharge nozzle 214. In the latter embodiment, the solid propellant gas generator is incorporated with the discharge nozzle 214. In this embodiment, the container 200 does not contain a breech or opening for a combined breech and cartridge, but rather the breech and cartridge are provided exterior to the container 200 and are connected to the discharge nozzle 214.

Returning to FIG. 2, the illustrated embodiment shows a permanent breech 204, a disposable solid propellant gas generator 206, and a lid 208, which can be sealed against and to the upper opening in the breech 204 to securely hold the solid propellant gas generator 206 within the breech 204 and container 200. The lid 208 contains a squib 210 to ignite the solid propellant within the solid propellant gas generator 206. The squib 210 is connected to an electrical conductor 213. Electrical conductor 213 is connected to a control system which can fire the squib 210 based on pre-programmed logic.

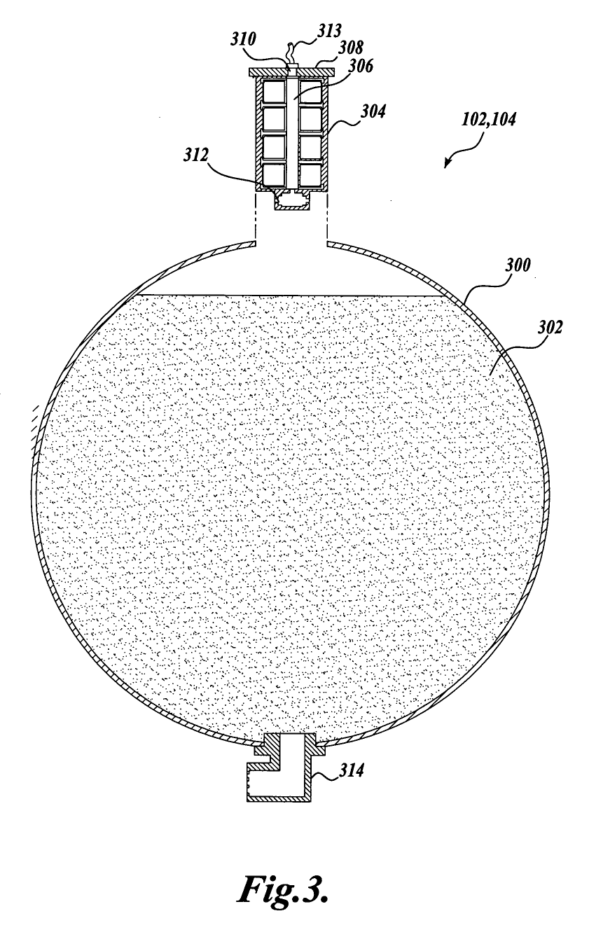

Referring to FIG. 3, an alternate embodiment of a fire extinguisher in accordance with the present invention is illustrated. The illustrated embodiment of a fire extinguisher in FIG. 3 includes a “drop in” solid propellant gas generator 306. The container 300 is spherical similar to the embodiment of FIG. 2. However, the container 200 of FIG. 3 can be a pre-existing container which may be for a Halon fire suppressant. The desire for environmentally responsible fire suppressants drives the move away from chlorine-containing fire suppressant to more environmentally compatible fire suppressants. Pre-existing Halon bottles, such as container 200, can be retrofitted by simply dropping in a solid propellant gas generator 306. In this embodiment, the solid propellant gas generator 306 fits within an aperture at the top of the container 300. The solid propellant gas generator 306 combines a breach 304 and discharge port 312 in a single unit. The discharge ports 312 are configured to provide neutral sideways thrust. The solid propellant gas generator 306 comes with an upper lid 308 to hermetically seal the solid propellant gas generator 306 to the container 300. A squib 310 is provided in the lid 308. The squib 310 is. connected to an activating mechanism via the electrical conductor 313. In this embodiment, the solid propellant gas generator 306 comprises the breach 304, the discharge ports 312, the lid 308, the squib 310, and an electrical conductor 313. Pre-existing containers 310 can be retrofitted simply by dropping in an assembled solid propellant gas generator 306. After discharge, the solid propellant gas generator 306, along with the breach 304 and the discharge port 312, can be removed as a unit from the container 300 and replaced with a fresh unit. In this manner, pre-existing containers 300 of Halon can be retrofitted simply by dropping in a solid propellant gas generator without the need for any substantial modification. The container 300 also includes a discharge nozzle 314 at the lower section of the container 300 similar to the embodiment illustrated in FIG. 2.

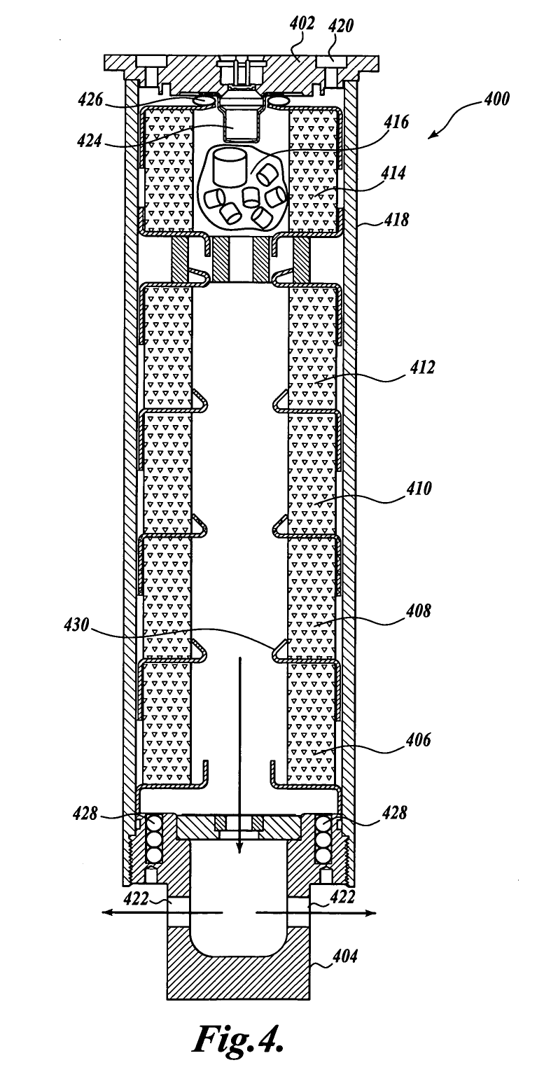

Referring to FIG. 4, a representative solid propellant gas generator 400 is illustrated. The solid propellant gas generator 400 includes a shell 418 forming the exterior. A lid 402 is coupled and attached to the upper end of the shell 418. The lid 402 includes a squib 424. The lid 402 may have apertures 420 for overpressure relief. At the opposite end of the shell 418 and opposite to the lid 402, a bottom closure 404 is provided. The bottom closure 404 may be threaded to the bottom end of the shell 418. The bottom closure 404 includes integrated discharge port holes 422 for discharge of the gas generated by the burning of the solid propellant. The discharge port holes 422 can comprise three discharge port holes spaced 120° apart around the circumference of the bottom closure 404. By providing discharge port holes that are equally distributed around the bottom closure 404, thrust will be neutral and any sideways thrust is eliminated. Although three discharge port holes 422 can be provided, balancing the thrust forces can be accomplished with two discharge port holes directly opposite to one another or more than three vent holes.

Igniter baggie 416 is located immediately below the squib 424. Two auto-ignition propellant (36A) pellets 426, spaced 180° apart, are provided adjacent to the squib 424. At the lower end of the shell 418, within the bottom closure 404, two holes are provided. Each hole is filled with three auto-ignition propellant pellets 428, spaced 180° apart.

Within the main body of the shell 418, annular zones of solid propellant 406, 408, 410, 412, and 414 are provided. The main propellant in these zones may be in grain shapes, such as cylinders (whole, hollow-centered, star, or rosette). Each zone of solid propellant 406, 408, 410, 412, and 414 is sectioned off above and below with a grain trap, of which grain trap 330 is representative. Each solid propellant zone 406, 408, 410, 412, and 414 can have similar characteristics, or each solid propellant zone 406, 408, 410, 412, and 414 can have different characteristics, or any two or more zones can be similar and the remainder different. For example, the solid propellant grains of each zone can be different in composition, or the grains of each zone can vary in size and surface area to provide the discharge profile as required. For example, small-sized solid propellant grains provide greater surface area per volume. Greater surface area means more area for combustion, therefore, greater volumes of gas will be produced and thus, higher pressures and greater volumes and/or mass discharge of fire suppressant from the bottle.

Zone 414 solid propellant can be spaced apart from solid propellant zones 406, 408, 410, and 412 by including stand-offs between the lower grain trap of zone 414 and the upper grain trap of zone 412. Solid propellant zone 414, which is located at the top of the shell 418 and surrounds the igniter baggie 416, may function as the “booster propellant.” Booster propellant can burn at a faster and hotter temperature and is provided to initiate the ignition of the gas generating solid propellant in zones 406, 408, 410, and 412. A representative booster propellant is known under the designation FS01-00.

The burning of the solid propellant in zones 406, 408, 410, 412, and 414 is initiated from the top zone 414 and can progress downwardly, wherein the last solid propellant to be combusted is in zone 406. Alternatively, the combustion can take place from the inside toward the outside. Accordingly, the characteristics of the solid propellant can change from top to bottom, or from inside to outside. The gases flow downwardly through the center cavity in the annular solid propellant zones 406, 408, 410, 412, and 414. The gases are redirected by the bottom closure 404 to flow laterally and radially and are then are expelled from apertures 422. In some embodiments, it may be preferable to have a higher discharge flow rate (higher pressure) at the beginning of the discharge profile to initially put out a fire, followed by a constant or gradually reducing (or increasing) discharge profile to prevent the fire from reigniting. This may be accomplished by providing the top zones 410 and 412 with greater surface area solid propellant grains, and then the bottom zones 408 and 410 could have larger grains and less surface area per volume or mass of solid propellant. Alternatively, each zone could have solid propellant grains with slightly less surface area than the previous, beginning with the top zone through the lowest zone. Alternatively, to create a constant overpressure in the bottle, each zone could have solid propellant grains with slightly greater surface area than the previous, beginning with the top zone through the lowest zone. This can also be accomplished by increasing the surface area of the solid propellant grains beginning with the smallest surface area on the inside of the annular zone and increasing the surface area toward the outside of the zone in a radial direction.

In alternative embodiments, higher discharge can occur at the beginning, about the middle, or at the end of the discharge profile by providing grains having greater surface area at the top zone, or at the middle zone, or in the bottom zone in the shell 418. Solid propellant grain surface area can gradually change through each zone, going from zone to zone, or be abrupt-going from zone to zone, but similar throughout a zone. Solid propellant grain surface area can gradually change from the inside moving toward the outside or be abrupt. In other embodiments, rather than adjust the surface area, the compositional make-up of the solid propellant in zones 406, 408, 410, and 412 is varied. For example, to produce greater pressures and thus higher volumes of gas, the composition of the solid propellant can include greater percentages of fuel. Therefore, by adjusting one of either the surface area per weight (or volume) of solid propellant and/or adjusting the compositional make-up of the solid propellant of one or more of the solid propellant zones 406, 408, 410, 412, and 414, the discharge profile produced by the gas generator 400 can have a substantially constant discharge profile, a gradually increasing discharge profile, a gradually decreasing discharge profile, a stepwise (either increasing or decreasing) discharge profile, or burst (a sudden spike) discharge profile. Furthermore, one, some, or all types of discharge profiles can be combined and incorporated into a single solid propellant gas generator.

Materials of construction for the shell 418, lid 402, bottom closure 404, and all other non-combustible gas generator components preferably can withstand the heat of combustion and are, therefore, metals such as stainless steels, alloys of nickel, titanium, and the like.

Suitable solid propellants include a fuel and an oxidizer. The solid propellant may optionally include a coolant, a chemically active agent, and an additive.

Representative fuels include 5-aminotetrazole and the potassium, zinc, or other salts thereof, bitetrazole and the potassium, zinc, or other salts thereof diazoaminotetrazole and the potassium, zinc, or other salts thereof, diazotetrazole dimer and its salts, guanidine nitrate, aminoguanidine nitrates, nitroguanidine, triazoles, triaminoguanidinium, diaminoguanidinium, and combinations thereof. The fuel can comprise 5% to 50% by weight of the solid propellant.

Representative oxidizers include alkaline metal nitrates, alkaline earth nitrates, phase-stabilized ammonium nitrates, perchlorates, iodates, and bromates. In one embodiment, the oxidizer is strontium nitrate. The oxidizer can comprise, 20% to 90% by weight of the soiled propellant.

Representative coolants include magnesium carbonate and magnesium hydroxide. The coolant may comprise 0% to 40% by weight of the solid propellant, preferably 5% to 40% by weight of the solid propellant.

The chemically active agents are chemicals that generate environmentally innocuous, fire suppressive reactive species that disrupt combustion processes. Representative chemically active agents include potassium iodide, potassium bromide, sodium chloride, lithium chloride, potassium iodate, potassium nitrate, potassium bromate, sodium nitrate, lithium perchlorate, ammonium nitrate phase-stabilized with potassium nitrate, alkali bromides such as potassium bromide, alkali borates such as potassium borate, alkali sulfates such as potassium sulfate, and combinations thereof. The chemically active agent can comprise, 5% to 40% by weight of the solid propellant.

Additives can be an iron-containing compound, a non-halide potassium compound, or a combination of these. Representative iron-containing compounds include ferric oxide, ferric carbonate, ferric oxalate, ferric chloride, ferric sulfate, ferric bromide, ferric iodide, ferric sulfonate, ferrocyanide salts, ferric ferrocyanide, potassium ferrocyanide, ammonium ferrocyanide, ferrous oxide, ferrous chloride, ferrous bromide, ferrocene, iron pentacarbonyl, iron nonacarbonyl, ferric acetylacetone, iron phthalocyanine, iron acetate, iron carbonyl, and iron cyanide dyes such as Milori Blue (ammonium ferroferricyanide) and Prussian Blue (ferric ferrocyanide). Representative non-halide potassium compounds include potassium tetrazole and triazole salts, such as potassium 5-aminotetrazole and potassium nitrotriazone, potassium acetate, potassium acetylacetonate, potassium bicarbonate, potassium carbonate, potassium hexacyanoferrate, potassium hydroxide, potassium pentane dionate, and potassium oxalate. The additive can comprise from about 1% to about 25% by weight, based on the weight of the solid propellant.

Hydrofluorocarbons and fluorocarbons lack heavy halogen atoms, such as chorine, bromine, and iodine, making hydrofluorocarbons and fluorocarbons primarily physically acting fire suppression agents, meaning hydrofluorocarbons and fluorocarbons function through cooling and dilution effects. As such, replacing fire suppression agents, such as Halon-1301, that can contain chlorine, bromine, or iodine, is inefficient and will require greater concentrations to attain the same effectiveness. To improve the effectiveness of the fluorocarbons and hydrofluorocarbons, the solid propellant can incorporate a chemically active agent, a coolant, and/or an additive in the solid propellant formulation. Additionally, switching to a solid propellant gas generator will also increase the available volume within the container that is formally occupied by a pressurizing gas. The incorporation of a chemically active agent into the solid propellant formulation can decrease the concentrations of fire suppressant agent necessary to extinguish a fire. For example, as an approximation, a fire extinguisher using a solid propellant without a chemically active agent may need to produce about 8%-10% concentration of fire suppressant agent. However, one with a chemically active agent may only require about 2%-5% concentration of fire suppressant agent to extinguish a similar fire.

Discharge profiles are plotted as pressure over time, or concentration of either the generated gas or fire suppressant in mole, weight, or volume percent over time. A discharge period is the elapsed time from initiation of the fire extinguisher to the substantial drop in pressure or elimination of the fire suppressant from the container. The pressure can be correlated to a mass or volumetric flow rate. The following illustrative figures represent pressure profiles that can be created with solid propellant grains of suitable size, shape, and dimensions. A relatively flat or constant pressure profile versus time will provide a substantially constant flow rate of fire suppressant. A profile having a positive slope will propel more fire suppressant as time increases, and a combination grain will propel more fire suppressant agent initially and then remain substantially constant over time.

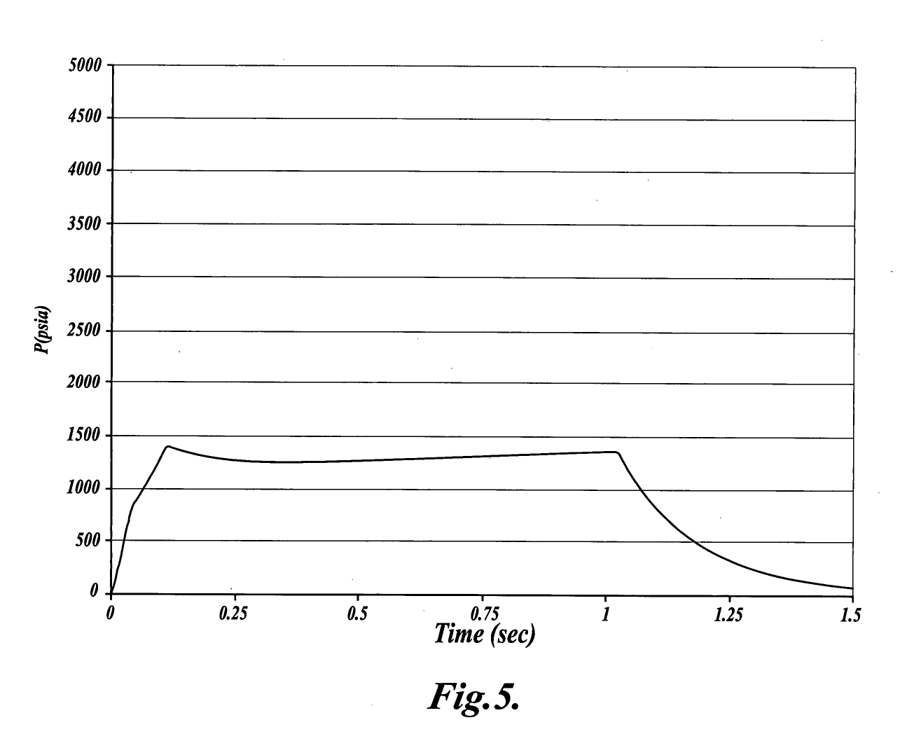

Referring to FIG. 5, one representative discharge profile is illustrated. The discharge profile is initiated at time equals zero seconds and continues for approximately 1½ seconds. This is the time required for the solid propellant to almost fully combust within the gas generator cartridge. In the illustrated discharge profile, the pressure produced at the initiation of the discharge profile and throughout the discharge profile is not greater than 1500 psia. The pressure of about 1500 psia is reached in about 1/10 of a second. From the time the pressure reaches about 1500 psia, the pressure is maintained until the elapsed time is about 1 second. Thereafter, the pressure decreases to about zero in about 0.5 seconds. The decrease in pressure from the elapsed time of one second to about 1½ seconds may be exponential or non-linear. The exponential decrease that follows the end of all discharge profiles should not be considered to be part of the discharge profile. Therefore, the discharge period does not include the exponential or non-linear decrease at the end.

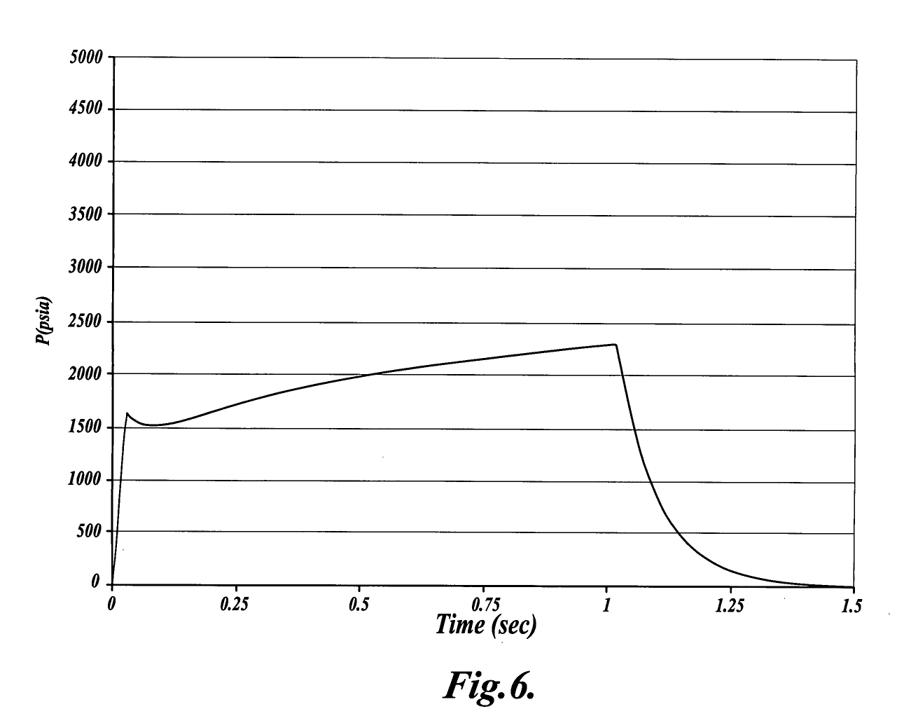

Referring to FIG. 6, a second representative discharge profile is illustrated. The elapsed time for the discharge profile illustrated in FIG. 6 is about 1½ seconds. Within about 0.05 of a second or less, the pressure reaches about 1500 psia, or slightly above. The pressure thereafter gradually rises to a maximum of about 2300 to 2400 psia in a total elapsed time of about 1 second. After 1 second, the pressure decreases to about zero psia after about 1½ elapsed seconds. The pressure decrease from 1 to 1½ seconds of elapsed time may be exponential or non-linear. The above pressures described in FIGS. 4 and 5 are merely to illustrate representative pressure discharge profiles and are not intended to limit the invention.

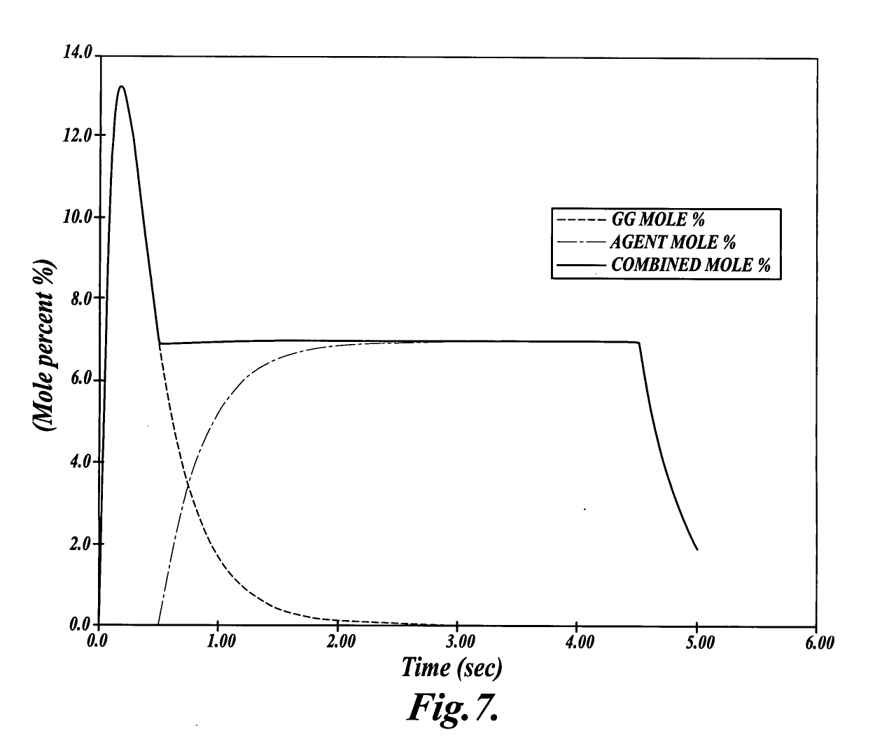

Referring to FIG. 7, a third representative discharge profile is illustrated. In this graph, the production of propellant gas is plotted versus the amount of fire suppressant discharged. The total elapsed time covered by the graph of FIG. 7 is about 5 seconds. At about 3/10 of a second or less, the combined mole percent reaches about 13% or slightly above 13%. From zero to about one-half of a second, the combined mole percent is, in essence, only the mole percent of the gas generator, because the fire suppressant agent has not yet been discharged. Because the fire suppressant agent has not yet been discharged, therefore, from about zero seconds to about one-half a second of elapsed time, the fire suppressant mole percent remains about zero. Therefore, the combined mole percent from zero seconds to one-half a second is essentially the gas generated by the solid propellant. From about one-half a second to about 4½ seconds of elapsed time, the combined mole percentage of gas generator gases and fire suppressant is substantially constant at about 7%. From about 3/10 of a second of elapsed time, or after reaching its peak to about 2 seconds, the gas generator mole percentage decreases exponentially. At 3 seconds of elapsed time, the gas generator mole percentage is essentially zero. From about one-half of a second to about 2 seconds, the fire suppressant agent mole percentage increases substantially exponentially to reach about 7%. Therefore, from about 2 seconds of elapsed time to about 5 seconds of elapsed time, the combined mole percentage is essentially only the fire suppressant agent mole percentage. At about an elapsed time of 4½ seconds, the combined mole percentage, which is essentially the fire suppressant mole percentage, decreases exponentially or non-linearly.

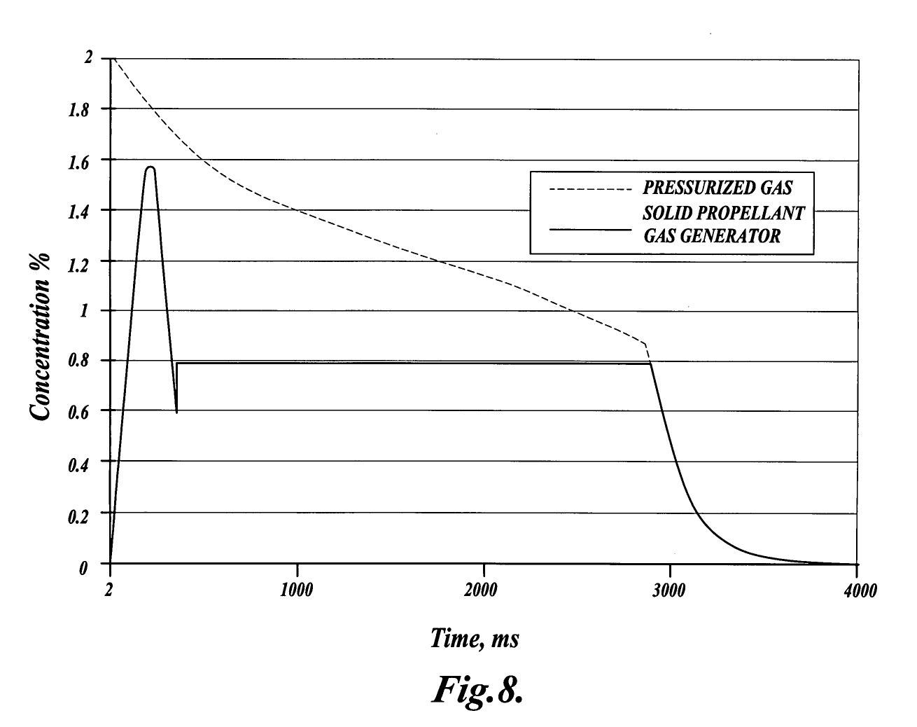

Referring to FIG. 8, a fourth representative embodiment of a discharge profile is illustrated. A comparison is illustrated between the discharge profile of a fire suppressant agent produced by a bottle containing a pressurized gas, which is a gas under ambient temperature, and the discharge profile of a gas produced by a solid propellant gas generator. The pressurized gas initially has a concentration of about 2% in the fire extinguisher bottle. Upon actuation, the pressurized gas decreases for a total elapsed time of about 3,000 milliseconds. Thereafter, the gas undergoes an exponential or non-linear decrease to about 4,000 milliseconds. In contrast, the gas produced by a solid propellant initially begins at a concentration of 0% in the bottle. After actuation, the concentration increases rapidly to about 1.6%, falling to about 0.8% after about a total elapsed time of about 300 milliseconds or less. From about 300 milliseconds to about 3,000 milliseconds, the concentration remains substantially the same at about 0.8%. From about 3,000 milliseconds to about 4,000 milliseconds, the concentration decreases exponentially or non-linearly.

An advantage arising from the use of a solid propellant for optimizing discharge profiles is that one can use less agent by delivering only the fire suppressant agent needed to maintain a fire-free zone. In a pressurized bottle, much more fire suppressant agent is delivered initially in order to ensure sufficient agent concentration later in the suppression discharge period. With a solid propellant gas generator, an early burst of suppressant can be used to extinguish the fire and then a longer-lasting, steady stream of suppressant can be discharged to prevent re-ignition. Alternatively, the discharge of fire suppressant agent can be maintained substantially constant throughout the discharge period. The area below each of the respective curves in FIG. 8 can be integrated to find the total amount of agent used in both cases.

The illustrated discharge profiles in FIGS. 5-8 are merely representative examples. It is to be understood that discharge profiles can be extended for longer or shorter durations, and greater or less pressure. Furthermore, the discharge profile can have spikes (high flow) at the beginning of the discharge profile, anywhere in the middle of the discharge profile, and towards the end of the discharge profile. Similarly, the discharge profile can be tailored to have a gradually increasing discharge profile or a gradually decreasing discharge profile. Similarly, combinations of gradually increasing and gradually decreasing profiles can be included in a single discharge profile, or spikes combined with gradually increasing or gradually decreasing profiles at the beginning, middle, or at the end of the discharge profile can also be developed.

While illustrative embodiments have been illustrated and described, it will be appreciated that various changes can be made therein without departing from the spirit and scope of the invention.

The embodiments of the invention in which an exclusive property or privilege is claimed are defined as follows:

1. A fire extinguisher, comprising:
a fire suppressant within a container; and
a solid propellant gas generator connected to the container, wherein the solid propellant gas generator contains a charge of solid propellant that pressurizes the container to propel the fire suppressant at a substantially constant flow rate for the majority of the discharge period of the fire suppressant from the container.

2. The fire extinguisher of claim 1, wherein the solid propellant gas generator produces an increase in the pressure within the container over time to account for the decrease in the fire suppressant from the container to maintain the flow rate substantially constant.

3. The fire extinguisher of claim 1, wherein the solid propellant gas generator comprises solid propellant arranged to expose an increasing amount of surface area for burning during the course of the discharge period of the fire suppressant from the container.

4. The fire extinguisher of claim 1, wherein a substantially constant mass flow rate includes an insubstantial increasing amount of flow, an insubstantial decreasing amount of flow, or both.

5. The fire extinguisher of claim 1, wherein the fire suppressant comprises a hydrofluorocarbon, a perfluorocarbon, CF₃CHFCH₃, C₄F₁₀, (CF₂)₄, HFC-125, HFC-23, HFC-227ea, HFC-236fa, and combinations thereof.

6. The fire extinguisher of claim 1, wherein the solid propellant gas generator comprises a solid propellant comprising a fuel and an oxidizer.

7. The fire extinguisher of claim 6, wherein the fuel comprises at least one of a 5-aminotetrazole or the potassium, zinc, or other salts thereof, bitetrazole or the potassium, zinc, or other salts thereof, diazoaminotetrazole or the potassium, zinc, or other salts thereof, diazotetrazole dimer or its salts, guanidine nitrate, aminoguanidine nitrate, nitroguanidine, triazole, triaminoguanidinium, diaminoguanidinium, or combinations thereof.

8. The fire extinguisher of claim 7, wherein the fuel comprises 5% to 50% by weight of the solid propellant.

9. The fire extinguisher of claim 6, wherein the oxidizer comprises at least one of an alkaline metal nitrate, alkaline earth nitrate, phase-stabilized ammonium nitrate, perchlorate, iodate, bromate, strontium nitrate, or combinations thereof.

10. The fire extinguisher of claim 9, wherein the oxidizer comprises 20% to 90% by weight of the solid propellant.

11. The fire extinguisher of claim 6, further comprising a coolant.

12. The fire extinguisher of claim 11, wherein the coolant comprises magnesium carbonate, magnesium hydroxide, or combinations thereof.

13. The fire extinguisher of claim 12, wherein the coolant comprises 5% to 40% by weight of the solid propellant.

14. The fire extinguisher of claim 6, further comprising a chemically active agent from at least one of a potassium iodide, potassium bromide, sodium chloride, lithium chloride, potassium iodate, potassium nitrate, potassium bromate, sodium nitrate, lithium perchlorate, ammonium nitrate phase-stabilized with potassium nitrate, alkali bromide, potassium bromide, alkali borate, potassium borate, alkali sulfate, potassium sulfate, or combinations thereof.

15. The fire extinguisher of claim 14, wherein the chemically active agent comprises from 5% to 40% by weight of the solid propellant.

16. The fire extinguisher of claim 6, further comprising an additive from at least one of an iron-containing compound, a non-halide potassium compound, or a combination thereof.

17. The fire extinguisher of claim 16, wherein the non-halide potassium compound includes at least one of a potassium carbonate, potassium tetrazole, triazole salts, potassium 5-aminotetrazole, potassium nitrotriazone, potassium acetate, potassium acetylacetonate, potassium bicarbonate, potassium hexacyanoferrate, potassium hydroxide, potassium pentane dionate, potassium oxalate, or combinations thereof.

18. The fire extinguisher of claim 16, wherein the iron-containing compound includes at least one of a ferric oxide, ferrocyanide salt, iron carbonyl, ferric carbonate, ferric oxalate, ferric chloride, ferric sulfate, ferric bromide, ferric iodide, ferric sulfonate, ferric ferrocyanide, potassium ferrocyanide, ammonium ferrocyanide, ferrous oxide, ferrous chloride, ferrous bromide, ferrocene, iron pentacarbonyl, iron nonacarbonyl, ferric acetylacetone, iron phthalocyanine, iron acetate, iron cyanide dye, ammonium ferroferricyanide, ferric ferrocyanide, or combinations thereof.

19. The fire extinguisher of claim 16, wherein the additive comprises from 1% to 25% by weight of the solid propellant.

20. The fire extinguisher of claim 1, wherein the solid propellant gas generator comprises a shell, lid, and bottom closure with discharge ports, wherein the solid propellant gas generator can be installed and replaced with a new solid propellant gas generator cartridge after use of the fire extinguisher.

21. A method for extinguishing a fire, comprising:
activating a solid propellant gas generator connected to a container containing a fire suppressant; and
discharging the fire suppressant from the container at a substantially constant flow rate for the majority of the discharge period of the fire suppressant from the container.
